(19) United States
(12) Patent Application Publication
(10) Pub. No.: US 2004/0229644 A1
(43) Pub. Date: Nov. 18, 2004

(54) Method and apparatus for changing phone number information in an electronic phonebook

(76) Inventors: Anders Heie, (US); Dandi Lynde-Redman, (US); Mateera Panichkul, (US)

Correspondence Address: Milan Patel, Patent Department, 6000 Connection Drive, Irving, TX, 75039, US

(21) Appl. No.: 09/735,240

(22) Filed: Dec. 11, 2000

(51) Int. Cl. H04M 1/00; H04M 3/00; H04B 1/38

(52) U.S. Cl. 455/551; 379/355.02

(57) ABSTRACT

The present invention is directed to a method and apparatus for editing phone numbers stored in an electronic book of an electronic device. A phonebook editor is provided for modifying a portion, such as an area code, of one or more phone numbers stored in the electronic phonebook. By providing a change criterion, an old area code and a new area code, all the phone numbers stored in the electronic phonebook matching the change criterion having the old area code can be modified to the new area code.

### FIELD OF THE INVENTION

The present invention relates to an electronic device having an electronic phonebook, more particularly, to a method and apparatus for facilitating phone number information changes within the electronic phonebook of the electronic device.

### BACKGROUND OF THE INVENTION

In a global communication system, communication devices such as a wireless mobile terminals or land-based terminals communicate with each other via use of a subscriber address (for example a phone number). The local phone companies assign the phone numbers to the communication devices upon activation of a communication subscription.

Generally, the phone number is defined as an N-digit number, wherein the value of N varies from one country to another. For example, in the United States N is valued at 10, so that the 10-digit phone number is defined as having a 3-digit area code followed by a 3-digit sub-area code followed by a 4-digit subscriber's number (for example, 333-333-3333). Other countries however, may have additional digits representing a country code (for example 358-46-444-4444).

The communication between two or more parties in a communication system is established when a calling party executes a dialing sequence using the communication device (such as a radio terminal). The dialing sequence comprises a phone number, wherein the user of the communication device must provide each digit of the phone number to complete the dialing sequence prior to executing the dialing sequence. The user must enter each digit of the phone number one at a time to complete the dialing sequence. Today, there are electronic devices such as a general-purpose computer, mobile phone, or personal digital assistant (PDA) which are provided with an electronic phonebook for storing one or more phone numbers. Some of these electronic devices having the electronic phonebook, further comprise communication capabilities or may be connected to a communication device. Initially, the user of the electronic device must enter and store the phone numbers manually into the electronic phonebook to create a list of phone numbers. Once the list of phone numbers is created, the user simply finds the stored phone and uses the phone number to establish communication without actually entering each digit of the phone number. Due to its ease of use and accessibility, users of the communication devices are storing large numbers of phone numbers into their electronic phonebooks. Some users create several lists of phone numbers, such as a business list, personal list or emergency contact list. However, a problem occurs when the phone companies modify part of one or more phone number. In the United States, the phone companies may select a list of phone numbers in a geographical area and modify the phone numbers in the area code to create more usable phone numbers. Typically, the phone companies determines a list of the phone numbers to be modified based on sub-area codes, wherein phone numbers with selected sub-area codes will be modified to have a new area code.

Recently, there has been a surge of new subscribers in the communication system. This surge has forced phone companies to modify area codes of phone numbers to allow for growth. Each time the Phone Company changes an area code, the phone companies attempt to notify the general public via local media, such as television or newspaper or the Internet.

However, this creates a great deal of confusion and inconvenience to the users of an electronic phone book. For every change made by the Phone company, the user of the electronic phonebook is required to determine which phone number was effected by the change and then modify the area code of the effected phone number. Confusion occurs when a user forgets to modify all the effected phone numbers or is not aware of a changed area code and later access the outdated phone number. This requires the user to change the electronic phonebook every time an area code changes, which is very inefficient and inconvenient. Especially, for those users maintaining a large list of phone numbers.

It would be very useful if the electronic phonebook was provided a method of updating all the phone numbers stored in the electronic phonebook that were affected by a change in area code or any other part of the phone number.

### SUMMARY OF THE INVENTION

The present invention advantageously provides an apparatus and an associated method, for an electronic device to facilitate editing the phone numbers stored in an electronic phonebook of an electronic device.

The present invention encompasses an electronic device, such as a mobile terminal, a personal digital assistant (PDA) or a computer, which may be operated in a communication system (for example CDMA, TDMA, GSM, etc.). The electronic device comprises a method of receiving a phone number change information and modifying the phone numbers stored in the electronic phonebook based on the number change information. The phone number change information may be received via a user interface. The phone number change information may also be received from the electronic device's internal database or received from an external database accessed via wireless communication link or land based communication link upon the request of the user.

A more complete appreciation of all the advantages and scope of the present invention can be obtained from the accompanying drawings, the following detailed description of the invention, and the appended claims.

### BRIEF DESCRIPTION OF THE DRAWINGS

FIG. 1 illustrates a block diagram of a mobile terminal into which an embodiment of the invention may be implemented;

FIG. 2 shows a communication system in which users receive phone number change notification and phone number change information;

FIG. 3 shows a phone number change table depiction of an embodiment of the invention; and

FIG. 4 shows a phonebook editor task software module depiction of an embodiment of the invention.

### DETAILED DESCRIPTION OF THE INVENTION

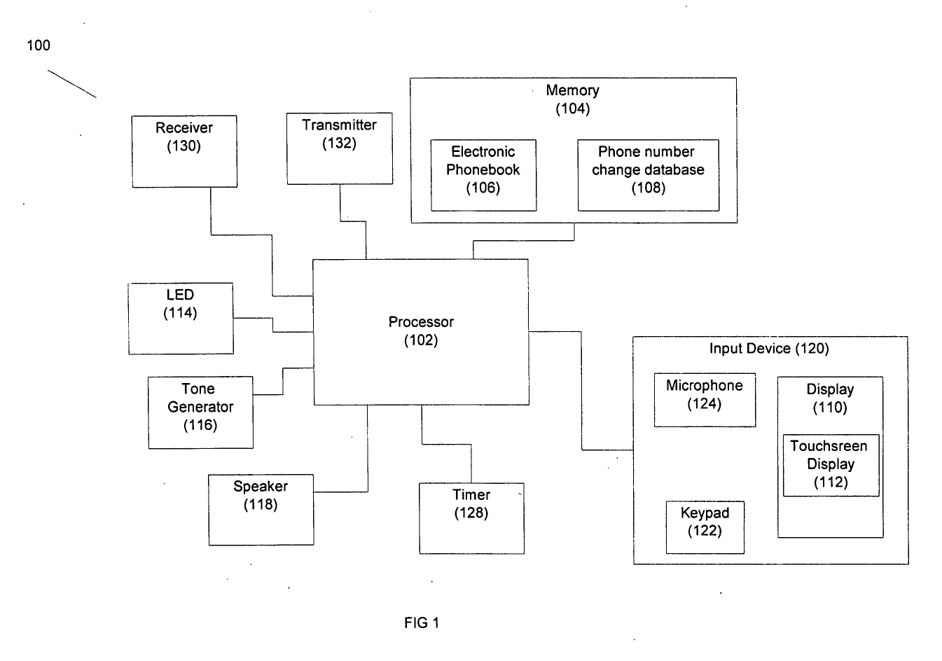

FIG. 1 is a block diagram of the electronic device, such as a mobile terminal 100, according to an embodiment of the invention. Generally, the mobile terminal 100 includes a controller 102 (which may also be known as a processor) coupled to various memories, collectively shown as memory 104. Memory 104 includes a plurality of stored constants and variables that are used by processor 102 during the operation of the electronic device 100. For example, memory 104 stores the values of the various feature parameters and the Number Assignment Module (NAM). The memory 104 is also hold an electronic phonebook 106 and a phone number change database 108. An operating program for controlling the operation of processor 102 is also stored in memory 104 (typically in a read only memory). Memory 104 is also used to store data provided by the user through the user interface. Furthermore, memory 104 is used to hold the subprograms or sub-processes for controlling the operation of mobile terminal 100 and carrying out the embodiment of the invention. The operating program in memory 104 includes routines for modifying phone numbers that are stored in an electronic phonebook 106.

The user interface of the mobile terminal 100 also includes a Liquid Crystal Display (LCD) 110, a touch-screen display 112, Light Emitting Diode (LED) 114, tone generator 116, speaker 118 and user input device 120, comprising alpha-numeric keypad 122, all of which are coupled to processor 102. The input device may also comprise microphone 124 for generating input and the touch screen display 112. Mobile terminal 100 also comprises timer 128 (also referred to as a clock chip) coupled to processor 102 for synchronizing the operations of processor 102 and tracking time.

The exemplary mobile terminal 100 also includes a receiver 130, transmitter 132, coupled to the processor 102. The processor 102, coupled to the transmitter 132 and the receiver 130, initiates the transmission of outgoing signals and processes incoming signals, respectively. These signals may include signaling information in accordance with the air interface of the applicable cellular or digital system and also user speech and/or user generated data. The outgoing signals may be used to request data from external databases and the incoming signals may include data presenting phone number change information.

Generally, the phone companies create a phone number change information. The phone number change information comprises a change information and a modification information. The change information comprises a change prefix (for example, an area code) and change criterion (for example, sub-area code), wherein the phone numbers matching the sub-area code having the change prefix are modified using the modification information. The modification information comprises the portion of the phone number being changed (for example a new area code). It should be noted that modification information represents a new change prefix. Thus, when change prefix represents a country code, the modification information will represent a new country code.

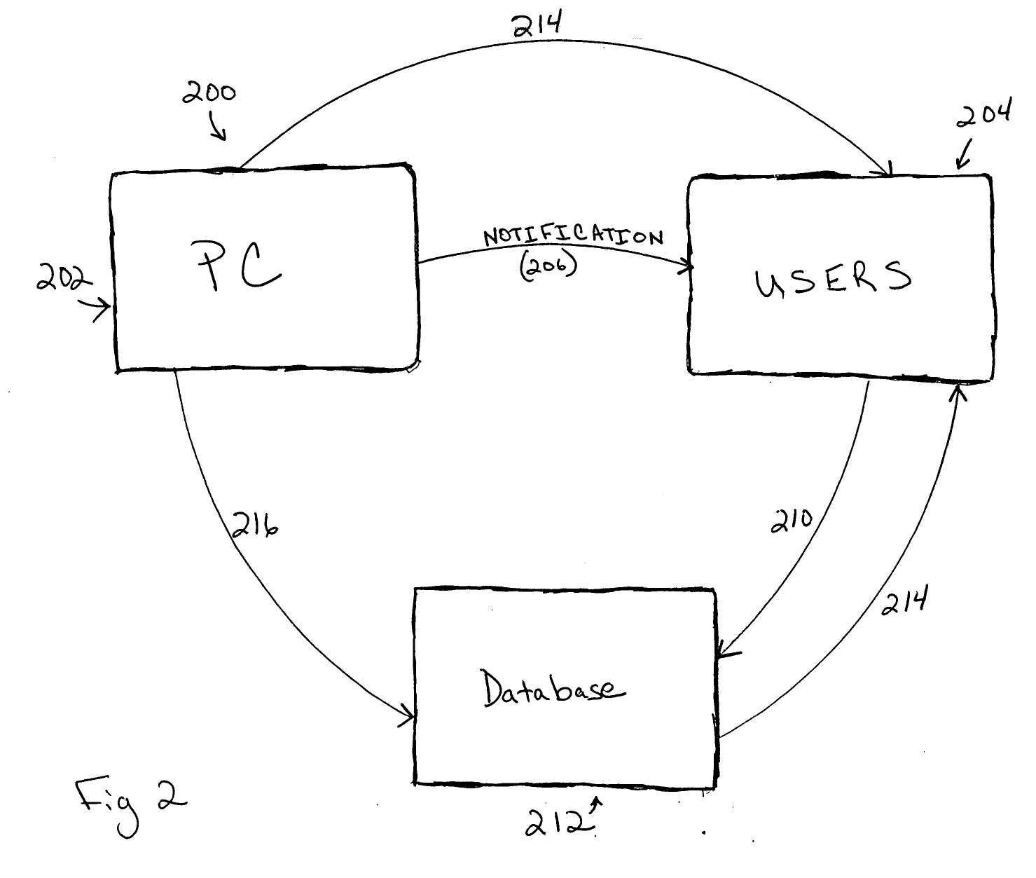

FIG. 2 shows a communication system 200 in which users receive phone number change notification and phone number change information. In the exemplary communication system, the phone companies 202 may provide a notification 206 to the users 204 indicating that certain phone numbers has changed. The notification 206 may be a publication of phone number change information in a newspaper, on the local news or on the Internet. The notification 206 may be a page message if the user has made arrangements with the phone companies. Upon receiving the notification 206, the user may send a request 210 to a database 212 to receive the phone number change information 214. Typically, the phone companies will download the phone number change information 214 into a database 212 before notifying the users 204. The phone companies may also send an electronic copy of the phone number change information 214 to the users 204, whereby the user may download the phone number change information 214 into an internal database of the electronic device, analogous to mobile terminal 100, used by the user.

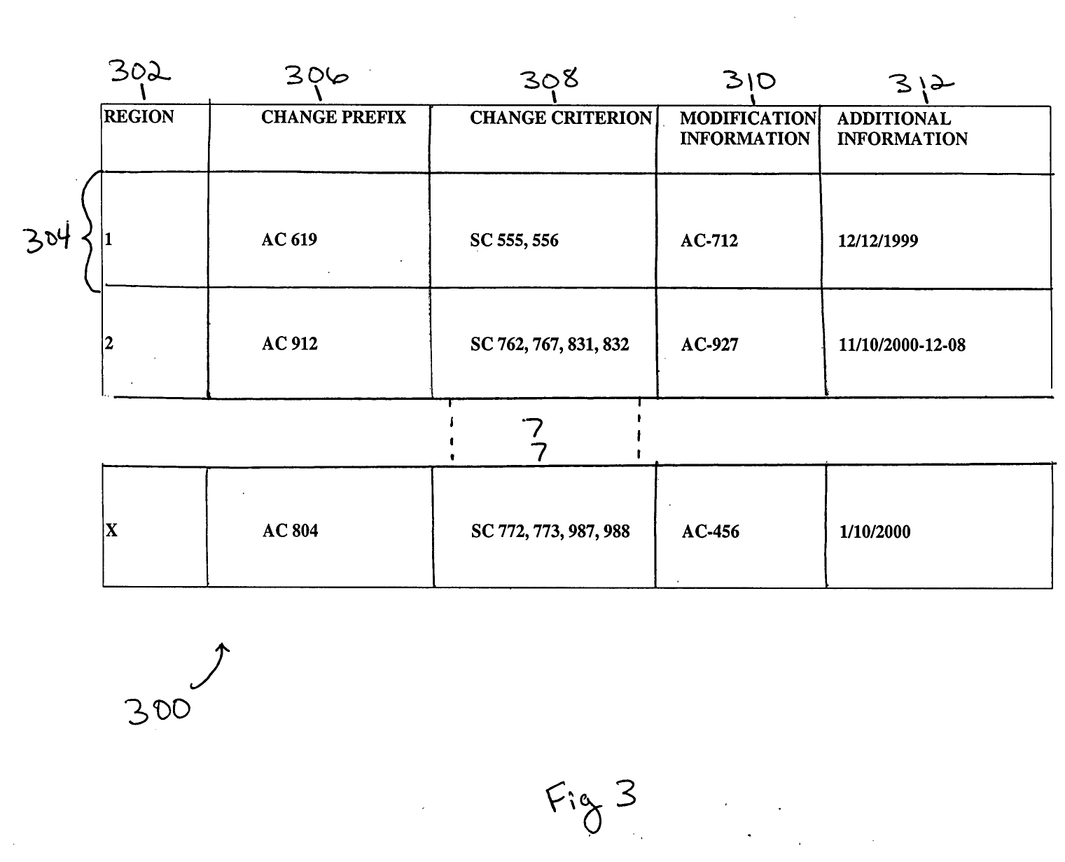

The Phone Company may create a database containing phone number change information for one or more regions 302. FIG. 3 shows an exemplary phone number change table 300 having one or more phone number change information 304, which may be stored in the database 212. The exemplary table 300 comprises a change prefix portion 306, a change criterion portion 308 and modification information portion 310. As show in FIG. 3, the change prefix portion 306 may contain single area code (AC), the change criterion portion 308 may contain one or more sub-area codes (SC) and the modification information 310 may contain a new area code (AC). Additionally, the table 300 may comprise an additional information portion 312 providing date information. The date information may be used to check when the phone number change information 304 was last updated. As an example, all the phone numbers matching an area code from the change prefix portion 306 and at least on of the sub-area code from the change criterion portion 308 will have a new area code from the modification portion 310. For example, all the phone numbers in the 619 area code with a 555 sub-area code will now be in 712 area code.

In an exemplary implementation of an electronic device, analogous to the mobile terminal 100 having an electronic phonebook 106, a phone book editor is provided for modifying phone numbers that are stored in the electronic phonebook 106. Using a menu feature of the mobile terminal 100, the user may activate the phonebook editor. Upon activating the phonebook editor, the user may choose to manually enter the phone number change information using the input device 120 of the mobile terminal 100. In the preferred embodiment, the user may also request to access a database to modify the phone numbers stored in the electronic phonebook 106. If the user decides to manually update the electronic phonebook 106 using the input device 120, then the user provides the change information and modification information. Once the user has provided the necessary information, the processor 102 searches the electronic phonebook 106 and modifies all phone numbers that match the user provided change criterion and the change prefix using the user provided modification information. To find one or more phone numbers affected by a change, the processor 102 may search using the change prefix first then the change criterion or the change criterion first then the change prefix. In a preferred embodiment, the processor 102 searches the electronic phonebook 106 to find one or more affected phone numbers by first generating a list of affected phone numbers using the change criterion, then narrowing the list using change prefix. The modification techniques used to modify the affected phone numbers may vary depending on manufacturer. For example, once an affected phone number is found, the affected phone number may be replaced with a new phone number having the modification information incorporated or only a portion of the affected phone may be replaced with the modification information.

If the user decides to access the database to update the phone numbers stored in the electronic phonebook 106, the user may be prompted to select an internal database 108 or an external database 212 comprising the phone number change table 300. In the preferred embodiment, the processor 102 first checks the internal database 108 for the table 100 before accessing external database 212. If the internal database is not available or if the table is outdated, then the processor 102 attempts to establish a communication link to pre-selected external database to retrieve the table 300. The phone number change table 300 may be downloaded into the internal database 108 prior to executing the phonebook editor or may be promptly downloaded into the internal database from an external database upon the user electing to access the database to update the phone numbers. Also, the Phone Company (PC) may also provide, via regular mail or e-mail, an electronic copy of the database, containing phone number change table 300. Upon receiving the electronic copy, the user may download the table 300 into the internal database of the mobile terminal 100. The processor 102 may download the entire table 300 into the internal database or download small portions of the table 300. The processor 102 is provided with well-known techniques to access data from an external source to receive data. For example, Wireless Application Protocols (WAP) may be used to access the table from a server on the Internet. The address to the server may be provided by the Phone Company and may be stored in the memory 104. Using the infrared port of the mobile terminal 100, the processor 102 may access a general-purpose computer to access the table from a database stored on the general-purpose computer.

Upon accessing the phone number change table 300, the processor 102 extracts the change prefix, the change criterion and the modification information for every entry listed in the change prefix portion of the table 300. Once the processor 102 extracts the necessary information, the processor 102 searches the electronic phonebook 106 and modifies all phone numbers that match the user provided change criterion and the change prefix using the user provided modification information. To find one or more phone numbers affected by a change, the processor 102 may search using the change prefix first then the change criterion or the change criterion first then the change prefix. In a preferred embodiment, the processor 102 searches the electronic phonebook 106 to find one or more affected phone numbers by first generating a list of affected phone numbers using the change criterion, then narrowing the list using change prefix. As stated above, the modification techniques used to modify the affected phone numbers may vary depending on manufacturer.

In an embodiment of an invention, the processor 102 also, searches the phone numbers stored in the electronic phonebook 106 to identify phone numbers that matched the change criterion but does not have the change prefix for a particular change information. These phone numbers are referred to as incomplete phone numbers. The processor 102 may generate a list of incomplete phone numbers and prompt the user to update the incomplete phone numbers. If the user selects to modify the incomplete phone numbers, the processor 102 adds the necessary information using the modification information to update the phone number. For example if the phone number stored in electronic phonebook 106 did not contain an area code (store as 555-4443), then processor 102 attempts to add the new area code (760) contained in the modification information to update the incomplete phone number (760-555-4443). The user may be prompted to modify each phone number not having the change prefix one at a time from the list or simultaneously modify the entire list of phone numbers.

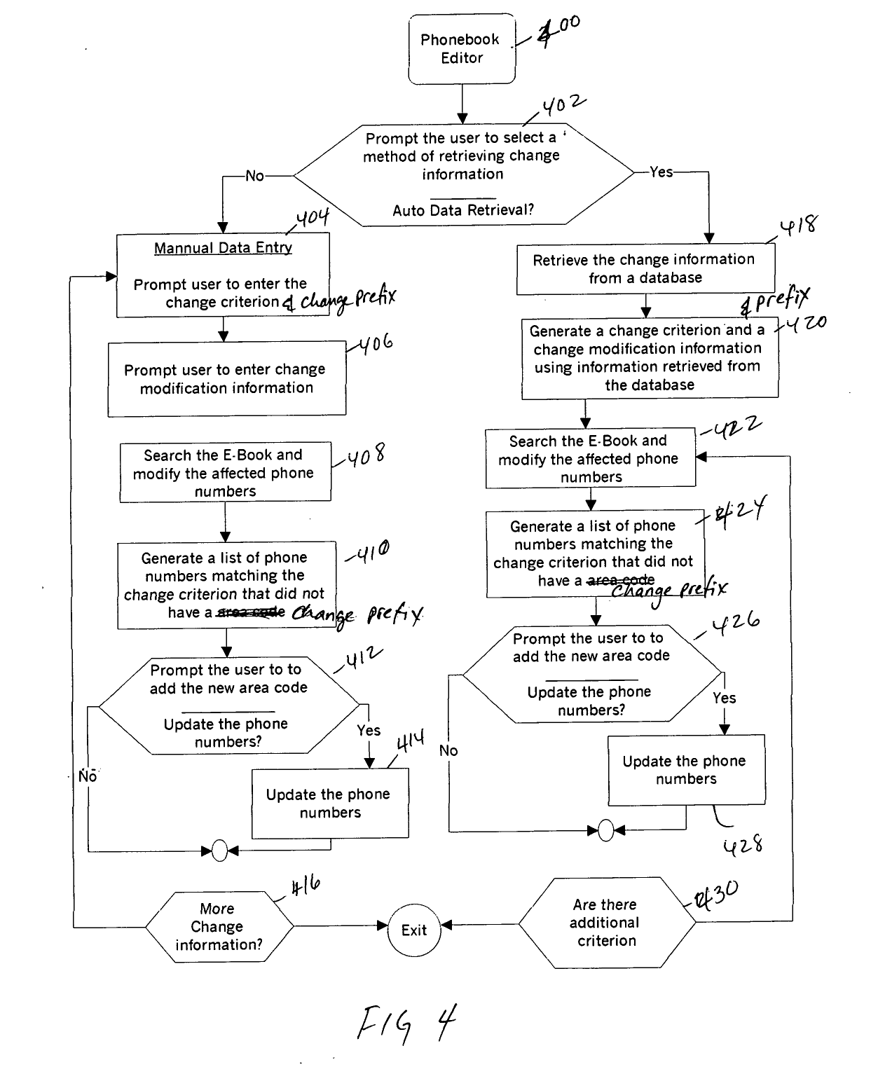

FIG. 4 describes a phonebook editor task 400 accordance to an embodiment of the invention for modifying and updating an electronic phonebook 106 of an electronic device. The user using a menu feature and an electronic device's input device initiates this task. At block 402, the processor 102 prompts the user to select a method of providing change information. The user may select an automatic data retrieval method or a manual data entry. If at block 402, the user selects to manually enter the phone number change information, then at block 404, the processor 102 prompts the user to enter the change criterion and change prefix. At block 406, upon the processor 102 receiving the change criterion and change prefix, the user is prompted to enter the modification information. Upon the processor 102 receiving the modification information, at block 408, the processor 102 searches the electronic phonebook 106 stored in memory 104, to find the phone numbers that matches the change criterion and the change prefix. In the preferred embodiment, upon finding a phone number (referred to as an affected phone number), the processor 102 modifies a portion of the affected phone number, the portion matching the change prefix using the modification information. In another embodiment, the processor 102 generates a new phone number using the modification number and replaces the affected phone number.

At block 410, the processor 102 generates a list of phone numbers that matched the change criterion but did not have the change prefix. At 412, the user is prompted to update the phone numbers with the modification information that does not have the change prefix. If the user elects to update the phone numbers, then at block 414, the processor 102 updates the phones using the modification information prior to executing block 416. At block 416, the user is prompted to continue with the phonebook editor task or exit. If the user elects to continue, then processor 102 re-executes block 404. This allows the user to enter more phone number change information.

Referring back to block 402, if the user elects to retrieve data automatically, then at block 418, the processor 102 executes data retrieval tasks to retrieve the data from either an internal or external database. Internal database is defined as the database stored in the memory 104 of the electronic device, for example the phone number change database 108. External database may be any database that is not in the memory 104 of the electronic device, such as a database that is at a server or in another electronic device. The processor 102 may access the external database by using off-shelf software or well-known techniques (such as Wireless Application Protocols to access the Internet). At block 420, upon retrieving the change information from the database, the processor 102 extracts the change criterion, the change prefix and the modification information using the information received from the database. At block 422, the processor 102 searches the electronic phonebook 106 stored in memory 104, to find the phone numbers that matches the change criterion and the change prefix. In the preferred embodiment, upon finding a phone number (referred to as an affected phone number), the processor 102 modifies a portion of the affected phone number, the portion matching the change prefix, using the modification information. In another embodiment, the processor 102 generates a new phone number using the modification number and replaces the affected phone number.

At block 424, the processor 102 generates a list of phone numbers that matched the change criterion but did not have the change prefix. At 426, the user is prompted to update the phone numbers with the modification information that did not have the change prefix. If the user elects to update the phone numbers, then at block 428, the processor 102 updates the phones to using the modification information prior to executing block 430. At block 430, the processor 102 determines if additional change criterions and/or change prefixes are available, then processor 102 re-executes block 422 to complete modifying the electronic phonebook 106.

As examples, the method and apparatus may also be implemented in electronic devices such as regular PDA, PDA with wireless communication capabilities, general-purpose computers, and devices having a wireless connection or landline connection methods. The method and apparatus may be realized by implementing an operating mode, which may be modified by the user using a menu feature.

Thus, while the invention has been particularly shown and described with respect to preferred embodiments thereof, the above description is intended by way of example only and is not intended to limit the present invention in any way except as set forth in the following claims.

What is claimed is:

1. A method of modifying phone numbers, stored in an electronic phonebook of an electronic device, the method comprising the steps of:
receiving, in the electronic device, a change information comprising a change prefix and a change criterion;
receiving, in the electronic device, a modification information;
searching the electronic phonebook to find one or more an affected phone numbers using said change information; and
modifying a portion of at least one of said one or more affected phone number using said modification information, if said one or more affected phone numbers are found in the electronic phonebook.

2. The method as claimed in claim 1, wherein said step of receiving change information comprises a step of receiving said change information from a user.

3. The method as claimed in claim 1, wherein said step of receiving change information further comprises step of receiving a phone number change table comprising said change information from a database.

4. The method as claimed in claim 3, wherein the step of receiving said phone number change table comprises a step of receiving said phone number change table from an internal database of the electronic device.

5. The method as claimed in claim 4, wherein the step of receiving phone number change table from said internal database further comprises a step of updating said internal database using an external database.

6. The method as claimed in claim 3, wherein the step of receiving change information further comprises a step of extracting said change information from said phone number change table.

7. The method as claimed in claim 3, wherein the step of receiving said phone number change table further comprises a step of receiving said phone number change table from an external database.

8. The method as claimed in claim 7, wherein the step of receiving phone number change table from said external database comprises a step of updating said internal database using said external database.

9. The method as claimed in claim 1, wherein the step of searching further comprises a step of generating a list of said affected phone numbers using said change criterion then narrowing said list of said affected phone number using said change prefix.

10. The method as claimed in claim 1, wherein the step of searching further comprises a step of generating a list of said affected phone number using said change prefix then narrowing said list of said affected phone number using said change criterion.

11. The method as claimed in claim 1, wherein the step of searching further comprises the step of identifying one or more incomplete phone numbers that match the change criterion but do not have said change prefix.

12. The method as claimed in claim 11, wherein the step of searching further comprises the step of adding said change prefix to at least one said incomplete phone numbers not having said change prefix.

13. The method as claimed in claim 1, wherein the step of modifying comprises the step of modifying a portion of all said affected phone numbers using said modification information, if one or more of said affected phone numbers are found in the electronic phonebook.

14. The method as claimed in claim 1, wherein the electronic device comprises a mobile phone.

15. The method as claimed in claim 1, wherein the electronic device comprises a personal digital assistant.

16. An electronic device, the electronic device comprising:
a memory having an electronic phonebook, the electronic phonebook for storing a plurality of phone numbers;
a processor coupled to the said memory, said processor for receiving change information comprising a change prefix and a change criterion; said processor further receiving a modification information, for searching the electronic phonebook to find one or more an affected phone numbers using said change information, and for modifying a portion of at least one of said one or more affected phone number using said modification information, if said one or more said affected phone numbers found in the electronic phonebook.

17. The electronic device as claimed in claim 16, further comprising:
an input device coupled to said processor; and
said processor further receives said change information from said input device.

18. The electronic device as claimed in claim 16, wherein said processor further receives a phone number change table comprising said change information from a database.

19. The electronic device as claimed in claim 18, wherein said database comprises an internal database stored in said memory of the electronic device.

20. The electronic device as claimed in claim 19, wherein said processor further updates said internal database using an external database.

21. The electronic device as claimed in claim 18, wherein said processor further extracts said change information from said phone number change table.

22. The electronic device as claimed in claim 18, wherein said database comprises an external database stored in said memory of the electronic device.

23. The electronic device as claimed in claim 22, wherein said processor further updates said internal database using said external database.

24. The electronic device as claimed in claim 16, wherein said processor further generates a list of said one or more affected phone number using said change criterion then narrows said list of said affected phone number using said change prefix.

25. The electronic device as claimed in claim 16, wherein said processor further generates a list of said one or more affected phone number using said change prefix then narrows said list of said affected phone number using said change criterion.

26. The electronic device as claimed in claim 16, wherein said processor further identifies one or more incomplete phone numbers that match the change criterion but do not have said change prefix.

27. The electronic device as claimed in claim 26, wherein said processor further adds said change prefix to at least one of said one or more incomplete phone numbers not having said change prefix.

28. The electronic device as claimed in claim 16, wherein said processor further modifies a portion of all said one or more affected phone numbers using said modification information, if said one or more affected phone numbers are found in the electronic phonebook.

29. The electronic device as claimed in claim 16, wherein the electronic device comprises a mobile phone.

30. The electronic device as claimed in claim 16, wherein the electronic device comprises a personal digital assistant.
